(19) United States
(12) Patent Application Publication
(10) Pub. No.: US 2012/0190353 A1
(43) Pub. Date: Jul. 26, 2012

(54) SYSTEMS, DEVICES AND METHODS FOR DYNAMIC SELECTION OF DATA AND TELECOMMUNICATION SERVICE PROVIDERS

(75) Inventor: Janis L. Harwell, Everett, WA (US)

(73) Assignee: INTERMEC IP CORP., Everett, WA (US)

(21) Appl. No.: 13/014,220

(22) Filed: Jan. 26, 2011

(51) Int. Cl. H04W 4/00

(52) U.S. Cl. 455/422.1

(57) ABSTRACT

Communication service providers systems are dynamically selected for use by a subscriber device such as cellular telephone, other mobile device, or landline telephone based on the current location of the subscriber device and automatically comparing communication service characteristics of the communication service provider systems to determine the least expensive or otherwise preferable service provider. The communication service characteristics may include items such as current usage rates, signal strength, available bandwidth and network speed. Once a communication service provider system is selected, service provider identification information is automatically communicated to the subscriber device to enable seamless or nearly seamless switching to the selected communication service provider system, even while a current communication session is in progress using another communication service provider system.

### BACKGROUND

1. Field

This disclosure generally relates to data and telecommunication services, and particularly to services provided by telecommunication service providers.

2. Description of the Related Art

As the number of service providers offering combinations of wireless telecommunication, Internet, satellite and cable services is growing, the choices for service having different usage rates, speeds and quality increases. This provides an opportunity to select the best service provider for a particular service in a given location (e.g., based on current usage rates, total cost, unused minutes, speed, available bandwidth, quality of service, etc.) but also increases the time and expense one must invest in choosing the best provider in a given situation.

### BRIEF SUMMARY

It is often difficult or impossible to switch between providers at every instance in which it would be beneficial to the end user or subscriber without manually contacting individual service providers or having an interruption in service. For example, currently, end users do not have a convenient, automatic method of switching from one wireless communications service provider or from one wireless network to another while they are using their mobile devices. As a result, they are not able to switch the current service provider system on which a current communication is being conducted (such as a current cellular telephone call) to the lowest cost network while that communication is in progress. They are also unable to switch their communication to a network with better connectivity, greater speed or more bandwidth while the communication is in progress. The same problems exist with landline and cable communications.

A computer-implemented method of selecting communication service providers may be summarized as including automatically acquiring communication service characteristics of available communication service providers; automatically selecting a first communication service provider system based on the first communication service provider system having preferable communication service characteristics as compared to communication service characteristics of a second communication service provider system; and automatically communicating identification information regarding the first communication service provider system to a first subscriber device to enable the first subscriber device to conduct a communication session with a second subscriber device using the identification information regarding the first communication service provider system. The communication service characteristics may include at least one of: a rate for use of communication services based on an amount of time, a rate for use of communication services based on an amount of data, wireless carrier signal strength, available network bandwidth, characteristics regarding network speed, or quality of communication services characteristic. The preferable communication service characteristics may be those characteristics that have at least one of: a lower rate for usage of communication services, a stronger signal strength, a higher bandwidth, a higher network speed, or a higher quality of service characteristics as compared to other communication service providers.

Automatically selecting the first communication service provider system may include receiving information regarding a location of the first subscriber device; storing the communication service characteristics of the first communication service provider system and the communication service characteristics of the second communication service provider system, wherein the communication service characteristics of both the first communication service provider system and the second communication service provider system are applicable to the location of the first subscriber device; and comparing the stored communication service characteristics of the first communication service provider system and the stored communication service characteristics of the second communication service provider system to determine which communication service provider system has preferable communication service characteristics based on the location of the first subscriber device. Automatically communicating identification information regarding the first communication service provider may occur while the first subscriber device conducts a current communication session on a first channel of communication with the second subscriber device via the second communication service provider system, and may further include sending information to the first subscriber device to enable the first subscriber device to switch to using the first communication service provider system to conduct the current communication session.

Sending information to the first subscriber device to enable the first subscriber device to switch to using the first communication service provider system to conduct the current communication session may include sending a request to the first subscriber device to use the first communication service provider system to open a second channel of communication with the second subscriber device; sending a request to the first subscriber device and/or the second subscriber device to synchronize the second channel of communication with the first channel of communication; and sending a request to the first subscriber device and/or the second subscriber device to terminate the first communication channel. The first subscriber device or second may be a wireless mobile device or a telephone. The communication session may include at least one of: a telephone call, a video conference call, a sending of or a receiving of an electronic message, or a session in which content of the session is streaming audio or video data.

The method may further include sending usage and rate information associated with the first subscriber device using the first communication service provider system to conduct the communication session. Automatically selecting the first communication service provider system based on the first communication service provider system having preferable communication service characteristics may be based at least in part on received prioritized communication service provider system selection preference information including instructions to select one communication service provider system over another based on particular individual communication service characteristics having a higher priority than other particular individual communication service characteristics.

A computer-implemented method of selecting communication service providers may be summarized as including receiving identification information at a first subscriber device regarding an available first communication service provider system having preferable communication service characteristics as compared to communication service characteristics of an available second communication service provider system; and conducting a communication session with a second subscriber device using the identification information regarding the first communication service provider system.

The method may further include sending information regarding a location of the first subscriber device to enable the received identification information regarding an available first communication service provider system to be based on the location of the first subscriber device.

Receiving identification information regarding the first communication service provider may occur while the first subscriber device is conducting a current communication session on a first channel of communication with the second subscriber device using the second communication service provider system, and wherein conducting a communication session with the second subscriber device using the identification information regarding the first communication service provider system may include opening a second channel of communication with the second subscriber device using the first communication service provider system; synchronizing the second channel of communication with the first channel of communication; and terminating the first communication channel and continuing the current communication session using the first communication service provider system instead of the second communication service provider system.

A system may be summarized as including a computer processor; a network interface for receiving information regarding communication service providers; a non-transitory memory communicatively coupled to the computer processor having computer-executable instructions stored thereon that when executed by the computer processor cause the computer processor to perform: automatically selecting a first communication service provider system based on the first communication service provider system having preferable communication service characteristics as compared to communication service characteristics of a second communication service provider system; and automatically communicating identification information regarding the first communication service provider system to a first subscriber device to enable the first subscriber device to conduct a communication session with a second subscriber device using the identification information regarding the first communication service provider system.

The communication service characteristics may include at least one of: a rate for use of communication services based on an amount of time, a rate for use of communication services based on an amount of data, wireless carrier signal strength, available network bandwidth, characteristics regarding network speed, or quality of communication services characteristic. The preferable communication service characteristics may be those characteristics that have at least one of: a lower rate for usage of communication services, a stronger signal strength, a higher bandwidth, a higher network speed, or a higher quality of service characteristics as compared to other communication service providers.

Selecting the first communication service provider system may include receiving information regarding a location of the first subscriber device; storing the communication service characteristics of the first communication service provider system and the communication service characteristics of the second communication service provider system, wherein the communication service characteristics of the first communication service provider system and second communication service provider system are applicable to the location of the first subscriber device; and comparing the stored communication service characteristics of the first communication service provider system and the stored communication service characteristics of the second communication service provider system to determine which communication service provider system has preferable communication service characteristics based on the location of the first subscriber device. The computer-executable instructions, when executed by the computer processor, may configure the computer processor to enable the automatically communicating identification information regarding the first communication service provider to occur while the first subscriber device is conducting a current communication session on a first channel of communication with the second subscriber device using the second communication service provider system, and wherein the computer-executable instructions, when executed by the computer processor, further cause the computer processor to perform sending information to the first subscriber device to enable the first subscriber device to switch to using the first communication service provider system to conduct the current communication session.

Sending information to the first subscriber device to enable the first subscriber device to switch to using the first communication service provider system for conducting the current communication session may include sending a request to the first subscriber device to use the first communication service provider system to open second channel of communication with the second subscriber device; sending a request to the first subscriber device or the second subscriber device to synchronize the second channel of communication with the first channel of communication; and sending a request to the first subscriber device or the second subscriber device to terminate the first communication channel. The subscriber device or the second subscriber device may be a wireless mobile device or a telephone. The communication session may include at least one of: a telephone call, a video conference call, a sending of or a receiving of an electronic message, or a session in which content of the session is streaming audio or video data.

The computer-executable instructions, when executed by the computer processor, may further cause the computer processor to perform sending usage and rate information associated with the first subscriber device using the first communication service provider system to conduct the communication session.

Automatically selecting the first communication service provider system based on the first communication service provider system having preferable communication service characteristics may be based at least in part on received prioritized communication service provider system selection preference information including instructions to select one communication service provider system over another based on particular individual communication service characteristics having a higher priority than other particular individual communication service characteristics.

A mobile communications device may be summarized as including a processor; a wireless transmitter coupled to the processor; a wireless receiver coupled to the processor; an input device coupled to the processor; an audio or video output device coupled to the processor; and a memory coupled to the processor having computer-executable instructions thereon that when executed by the processor cause the processor to operate with the transmitter and the receiver to: receive identification information at the mobile device regarding an available first communication service provider system having preferable communication service characteristics as compared to communication service characteristics of an available second communication service provider system; and conduct a communication session with a subscriber device using the identification information regarding the first communication service provider system.

The computer-executable instructions, when executed by the processor, may further cause the processor to send information regarding a location of the mobile device to enable the received identification information regarding an available first communication service provider system to be based on the location of the mobile device.

The computer-executable instructions, when executed by the processor, may configure the processor to receive identification information regarding the first communication service provider while the mobile conducts a current communication session on a first channel of communication with the subscriber device using the second communication service provider system, and wherein the subscriber device conducts the communication session using the identification information regarding the first communication service provider system by opening a second channel of communication with the subscriber device using the first communication service provider system; synchronizing the second channel of communication with the first channel of communication; and terminating the first communication channel and continuing the current communication session using the first communication service provider system instead of the second communication service provider system.

At least one non-transitory computer-readable medium that may store instructions that when executed by at least one computer system may cause the at least one computer system to perform: automatically selecting a first communication service provider system based on the first communication service provider system having preferable communication service characteristics as compared to communication service characteristics of a second communication service provider system; and automatically communicating identification information regarding the first communication service provider system to a first subscriber device to enable the first subscriber device to conduct a communication session with a second subscriber device using the identification information regarding the first communication service provider system. The communication service characteristics may include at least one of: a rate for use of communication services based on an amount of time, a rate for use of communication services based on an amount of data, wireless carrier signal strength, available network bandwidth, characteristics regarding network speed, or quality of communication services characteristic. The preferable communication service characteristics may be those characteristics that have at least one of: a lower rate for usage of communication services, a stronger signal strength, a higher bandwidth, a higher network speed, or a higher quality of service characteristics as compared to other communication service providers.

Automatically selecting the first communication service provider system may include receiving information regarding a location of the first subscriber device; storing the communication service characteristics of the first communication service provider system and the communication service characteristics of the second communication service provider system, wherein the communication service characteristics of the first communication service provider system and second communication service provider system are applicable to the location of the first subscriber device; and comparing the stored communication service characteristics of the first communication service provider system and the stored communication service characteristics of the second communication service provider system to determine which communication service provider system has preferable communication service characteristics based on the location of the first subscriber device.

The instructions, when executed by the at least one computer system, may configure the at least one computer system to enable the automatically communicating identification information regarding the first communication service provider to occur while the first subscriber device is conducting a current communication session on a first channel of communication with the second subscriber device using the second communication service provider system, and wherein the instructions, when executed by the at least one computer system, may further cause the at least one computer system to perform sending information to the first subscriber device to enable the first subscriber device to switch to using the first communication service provider system for conducting the current communication session.

Sending information to the first subscriber device to enable the first subscriber device to switch to using the first communication service provider system for conducting the current communication session may include sending a request to the first subscriber device to use the first communication service provider system to open a second channel of communication with the second subscriber device; sending a request to the first subscriber device or the second subscriber device to synchronize the second channel of communication with the first channel of communication; and sending a request to the first subscriber device or the second subscriber device to terminate the first communication channel. The subscriber device or the second subscriber device may be a wireless mobile device or a telephone. The communication session may include at least one of: a telephone call, a video conference call, a sending of or a receiving of an electronic message, or a session in which content of the session is streaming audio or video data.

The instructions, when executed by the at least one computer system, may further cause the at least one computer system to perform sending usage and rate information associated with the first subscriber device using the first communication service provider system to conduct the communication session.

Automatically selecting the first communication service provider system based on the first communication service provider system having preferable communication service characteristics may be based at least in part on received prioritized communication service provider system selection preference information including instructions to select one communication service provider system over another based on particular individual communication service characteristics having a higher priority than other particular individual communication service characteristics.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a system diagram of a networked environment, in which systems, devices and methods for dynamic selection of data and telecommunication service providers may be a part, or in which they may be implemented, according to one illustrated embodiment.

FIG. 2 is a schematic diagram of an example computer system of the service cost tracking system, bill payment system or service provider system of FIG. 1, suitable for implementing systems, devices and methods for dynamic selection of data and telecommunication service providers, according to one illustrated embodiment.

FIG. 3 is a schematic view of one of the mobile devices of FIG. 1, shown in more detail according to one illustrated embodiment, the mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), and a power source.

FIG. 4 is a system diagram of the architecture of a system for dynamic selection of data and telecommunication service providers showing various types of information that are communicated between the mobile devices, service providers, and the service provider tracker, according to one illustrated embodiment.

FIG. 5 is a block diagram illustrating switching from one service provider to another in the system for dynamic selection of data and telecommunication service providers shown in FIG. 4, according to one illustrated embodiment.

FIG. 6 is a diagram representing a database schema for tracking rates and communication capabilities of service providers for various locations used by the service provider tracker.

FIG. 7 is a flow diagram showing a method of providing dynamic selection of data and telecommunication service providers, according to one illustrated embodiment.

FIG. 8 is a flow diagram showing a method of providing dynamic selection of data and telecommunication service providers, according to another illustrated embodiment.

FIG. 9 is a flow diagram showing a method of providing dynamic selection of data and telecommunication service providers, according to another illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

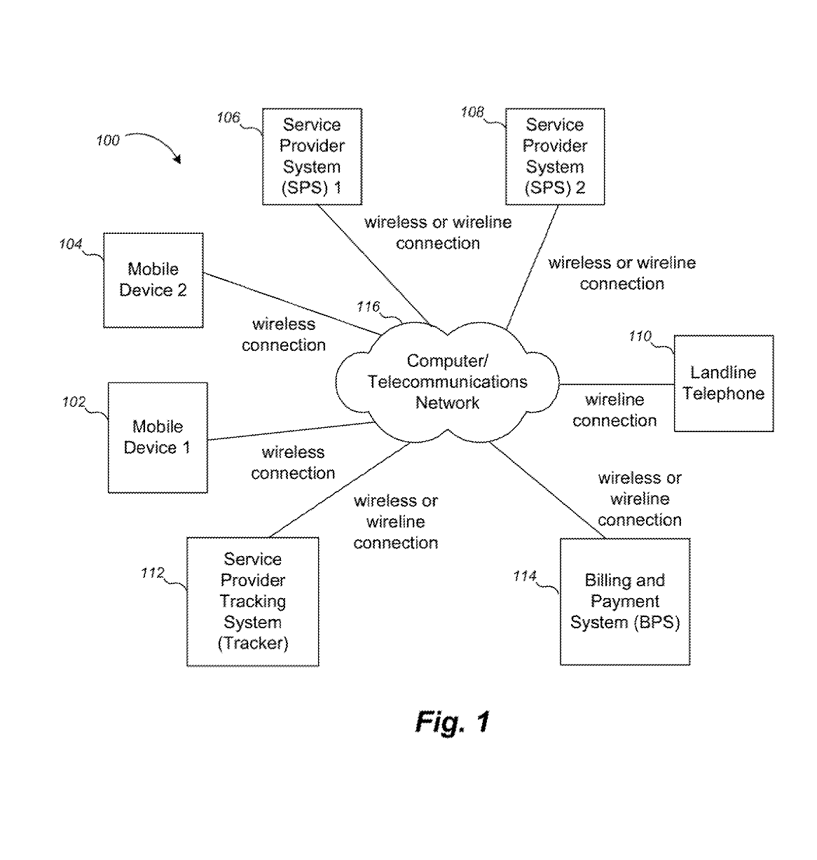

FIG. 1 shows a networked environment 100, in which systems, devices and methods for dynamic selection of data and telecommunication service providers may be a part, or in which they may be implemented, according to one illustrated embodiment.

The networked environment 100 may include a plurality of mobile devices (e.g., mobile device 1 102 and mobile device 2 104), a plurality of service provider systems (e.g., service provider system (SPS) 1 106 and service provider system (SPS) 2 108), one or more landline telephones (e.g., landline telephone 110), a service provider tracking system (tracker) 112 and a billing and payment system (BPS) 114. The mobile device 1 102 and mobile device 2 104, service provider system (SPS) 1 106 and service provider system (SPS) 2 108, landline telephone 110, service provider tracking system (tracker) 112 and the billing and payment system (BPS) 114 are all communicatively coupled via a computer/telecommunications network 116. Additional mobile devices, landline telephones and service providers may also be present and included in the network environment, but are not illustrated for clarity of presentation.

The computer/telecommunications network 116 may be any telecommunications network, computer network or combination of telecommunications and computer networks that enables communication between the various devices connected to the network 116 shown in FIG. 1. For example, mobile telecommunications provided by network 116 may include various digital mobile telecommunications including those according to the International Mobile Telecommunications-2000 (IMT-2000), better known as the 3rd Generation (3G), family of standards for mobile telecommunications fulfilling specifications by the International Telecommunication Union.

The mobile devices 104 and 106, the landline telephone 110, SPS 106, SPS 108, tracker 112 and BPS 114 may be additionally or optionally linked by one or more other communication links or networks that comprise network 116.

For example, a communications network of network 116 may include a local area network that uses wireless fidelity (Wi-Fi) high frequency radio signals to transmit and receive data over distances of a few hundred feet. The local area network may be a wireless local area network (WLAN) based on the Institute of Electric and Electronic Engineers (IEEE) 802.11 standards. However, other wired and wireless communications networks and protocols may be used to link the various devices and systems shown in FIG. 1. Thus, the mobile devices 102 and 104 may have various applicable wireless transmitters and receivers and, in the case of using a Wi-Fi wireless link, may also have the corresponding executable Wi-Fi compatible network communications software that initiates, controls, maintains or manages the wireless link between the mobile devices 102 and 104 and the various other devices and systems within or connected to network 116 over the Wi-Fi signal of the network 116.

The network 116 may comprise connections to computing systems such as SPS 1 and SPS 2 that provide services to the mobile devices 102 and 104 and landline telephone 110 (i.e., a server-based network), and may itself represent multiple interconnected networks. For instance wired and wireless enterprise-wide computer networks, intranets, extranets, and/or the Internet may be included in or comprise a part of network 116. Embodiments may include various types of communication networks including other telecommunications networks, cellular networks, paging networks, and other mobile networks. There may be any variety of computers, switching devices, routers, bridges, firewalls, edge devices, multiplexers, phone lines, cables, telecommunications equipment and other devices within network 116 and/or in the communications paths between the mobile devices 104 and 106, the landline telephone 110, SPS 106, SPS 108, tracker 112 and BPS 114. Some or all of such equipment of network 116 may be owned, leased or controlled by service providers such as SPS 106 and SPS 108.

In accordance with an aspect of the disclosure, the mobile devices 102 and 104 and landline telephone 110 may contain discrete functional program modules that might make use of an application programming interface (API), or other object, software, firmware and/or hardware, to request services of one or more of the other entities within or connected to the network 116, such as SPS 106, SPS 108, BPS 114 and tracker 112. For example, communication can be provided over a communications medium, e.g., client and server systems running on any one of the mobile device 1 102, mobile device 2 104, SPS 106, SPS 108, landline telephone 110, tracker 112 and BPS 114. These client and server systems may be coupled to one another via transmission control protocol/internet protocol (TCP/IP) connection(s) for high-capacity communication. The “client” is a member of a class or group that uses the services of another class or group to which it is not related. In computing, a client is a process, i.e., roughly a set of instructions or tasks, executed by hardware that requests a service provided by another program. Generally, the client process utilizes the requested service without having to “know” any working details about the other program or the service itself. In a client/server architecture, particularly a networked system, a client is usually a computer or device that accesses shared network resources provided by another computer or device, e.g., a server. In the example of FIG. 1, the mobile devices 102 and 104 and landline phone 110 may be clients requesting the services of the tracker 112 that is acting as a server. However, any entity in FIG. 1, including mobile devices 102 and 104, can be considered a client, a server, or both, depending on the circumstances.

One or more cellular towers and stations may be part of a cellular network that is part of the computer/telecommunications network 116 and may be communicatively linked by one or more communications networks or communication mediums within the computer/telecommunications network 116 (e.g., using a cellular or other wired or wireless signal 116) in order to facilitate sending and receiving information in the form of synchronous or asynchronous voice communications, video or textual data to and from the mobile devices 102 and 104. This communication may be over a wireless signal on the cellular network of network 116 using applicable combinations and layers of telecommunications and networking protocols and standards such as 3G, HTTP and TCP/IP, etc.

Although the physical environment of the network 116 may have connected devices such as computers, the physical environment may alternatively have or be described as comprising various digital devices such as personal digital assistants (PDAs), televisions, MP3 players, etc., software objects such as interfaces, Component Object Model (COM) objects and the like.

There are a variety of systems, components, and network configurations that may also support distributed computing environments within the network 116. For example, computing systems may be connected together within the network 116 by wired or wireless systems, by local networks or by widely distributed networks. Currently, many networks are coupled to the Internet, which provides an infrastructure for widely distributed computing and encompasses many different networks. Any such infrastructures, whether coupled to the Internet or not, may be used in conjunction with, be connected to, or comprise part of the network 116.

The mobile devices 104 and 106 can take the form of any of a large variety of mobile communications and/or processing devices having a handheld form factor. Examples of such may include cellular phones, personal digital assistants or PDAs (e.g., Blackberry® devices, iPhone® devices, Palm Pre® devices, Android® devices), cellular enabled laptop computers, netbook computers and tablet devices (e.g., IPAD® device).

The service provider systems 106 108 may be any telecommunication, data, or other communication service provider systems that facilitate communications between any two devices on the computer/telecommunications network 116. For example, a service provider may be a cellular telephone service provider, landline telephone service provider, Internet service provider, Wi-Fi access service provider, cable service provider, satellite service provider, other data service provider, or a service provider providing any combination of such services, etc. Generally, the service provider charges subscribers for use of the services provided. In the example provided herein, mobile device 1, mobile device 2 and landline telephone 110 are referred to as subscriber devices because they are devices belonging to or used by those who subscribe directly or indirectly to services provided by a service provider system (e.g., SPS 106 or SPS 108). Also, the functions performed by the tracker 112, BPS 114 service provider systems 106 and 108 may be performed by one or more systems connected to network 116 that combine the functionalities of those systems described above.

Although not required, the embodiments will be described in the general context of computer-executable instructions, such as program application modules, objects, or macros stored on computer- or processor-readable storage media and executed by a computer or processor. Those skilled in the relevant art will appreciate that the illustrated embodiments as well as other embodiments can be practiced with other system configurations and/or other computing system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network such as network 116. In a distributed computing environment, program modules may be located in both local and remote memory storage devices.

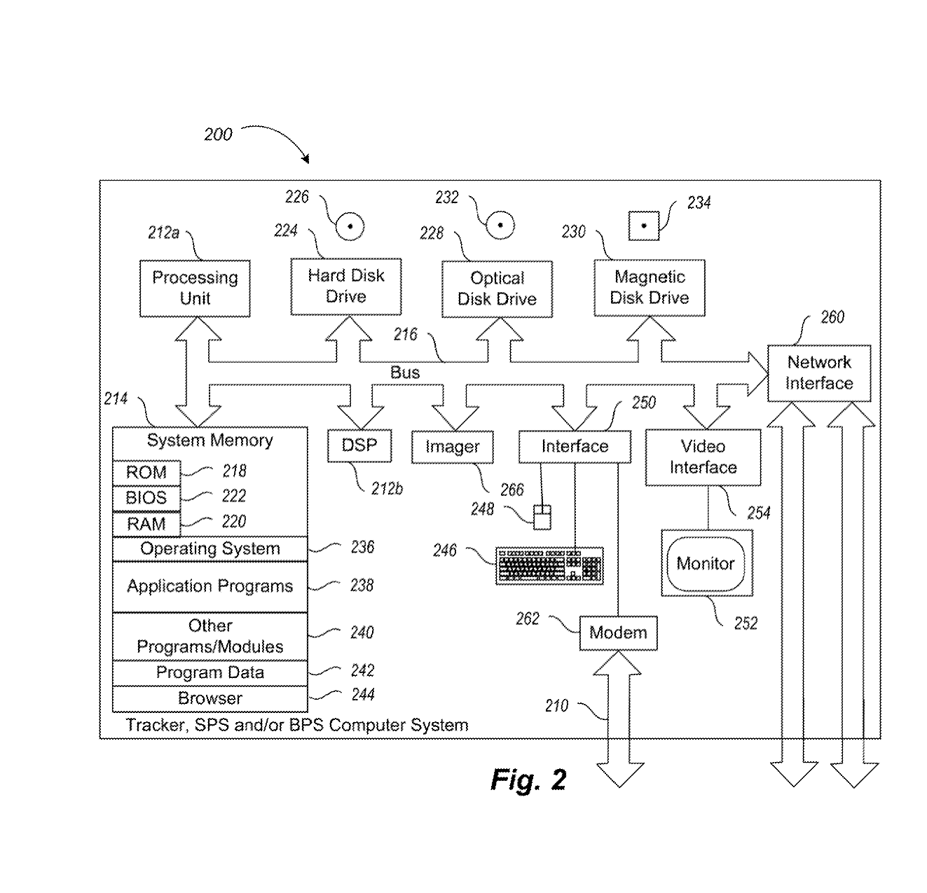

FIG. 2 is a schematic diagram of an example computer system of the tracker 112, SPS 106 or 108 and/or BPS 114 of FIG. 1. The computer system 200 is suitable for implementing systems, devices and methods for dynamic selection of data and telecommunication service providers, according to one illustrated embodiment. The computer system 200 will at times be referred to in the singular herein, but this is not intended to limit the embodiments to a single device since in typical embodiments, there may be more than one computer system or devices involved. Unless described otherwise, the construction and operation of the various blocks shown in FIG. 2 are of conventional design. As a result, such blocks need not be described in further detail herein, as they will be understood by those skilled in the relevant art.

The computer system 200 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the computer system 200, such as during start-up.

The computer system 200 may also include a plurality of interfaces such as network interface 260, interface 250 supporting modem 262 or any other wireless/wired interfaces.

The computer system 200 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program modules and other data for the computer system 200. Although the depicted computer system 200 is illustrated employing a hard disk 224, optical disk 228 and magnetic disk 230, those skilled in the relevant art will appreciate that other types of computer-readable storage media that can store data accessible by a computer may be employed, such as magnetic cassettes, flash memory, digital video disks (“DVD”), Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 212a.

Program modules can be stored in the system memory 214, such as an operating system 236, one or more application programs 238, other programs or modules 240 and program data 242. Application programs 238 may include instructions that cause the processor(s) 212 to automatically provide dynamic selection of data and telecommunication service providers before or during communications between various devices such as, for example, mobile device 1 102, mobile device 2 104 and landline telephone 110 of FIG. 1. Other program modules 240 may include instructions for handling security such as password or other access protection and communications encryption. The system memory 214 may also include communications programs, for example, a Web client or browser 244 for permitting the computer system 200 to access and exchange data with sources such as Web sites of the Internet, corporate intranets, extranets, or other networks and devices as described herein, as well as other server applications on server computing systems. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the computer system 200 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The computer system 200 can include other output devices, such as speakers, printers, etc.

The computer system 200 can operate in a networked environment using logical connections to one or more remote computers and/or devices as described above with reference to FIG. 1. For example, the computer system 200 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

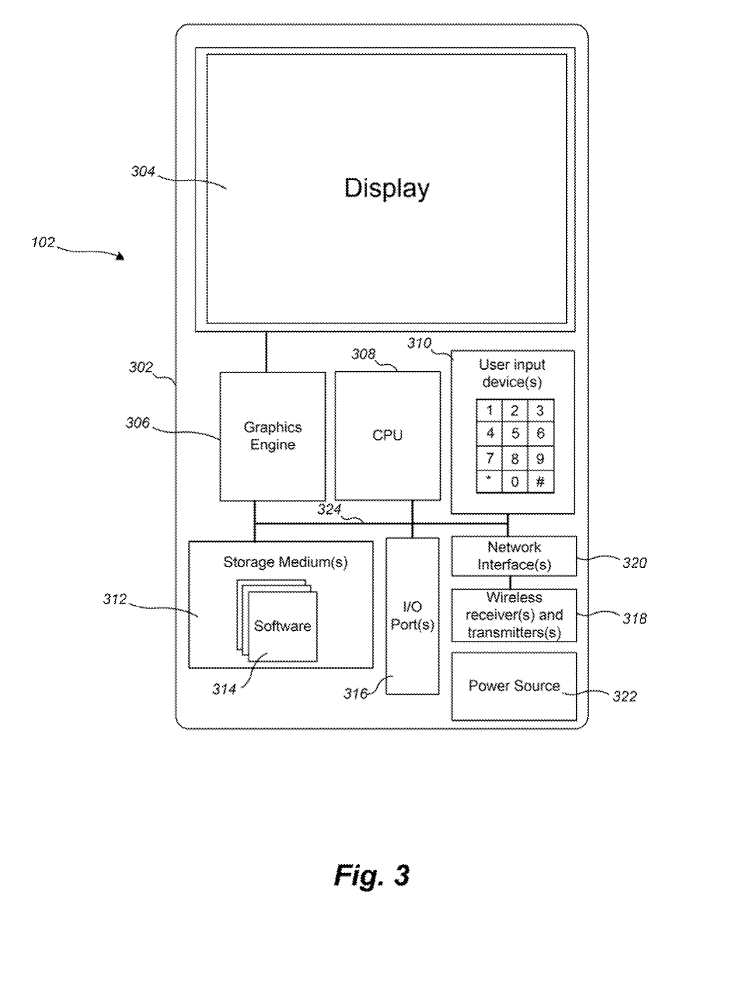

FIG. 3 shows the mobile device 1 102 of FIG. 1 in more detail according to one example embodiment. The mobile device 1 102 may have a housing 302, a display 304, a graphics engine 306, a central processing unit (CPU) 238, one or more user input devices 310, one or more storage mediums 312 having various software modules 314 stored thereon comprising instructions that are executable by the CPU 308, input/output (I/O) port(s) 316, one or more wireless receivers and transmitters 318, one or more network interfaces 320, and a power source 322.

As previously noted, the mobile device 1 102 may be any of a large variety of communications devices such as a cellular telephone, a portable media player (PMP), a personal digital assistant (PDA), a mobile communications device, a portable computer with built-in or add-on cellular communications, a portable game console, a global positioning system (GPS), a handheld industrial electronic device, or the like, or any combination thereof. The mobile device 1 102 has at least one central processing unit (CPU) 308 which may be a scalar processor, a digital signal processor (DSP), a reduced instruction set (RISC) processor, or any other suitable processor. The central processing unit (CPU) 308, display 304, graphics engine 306, one or more user input devices 310, one or more storage mediums 312, input/output (I/O) port(s) 316, one or more wireless receivers and transmitters 318, and one or more network interfaces 320 may all be communicatively connected to each other via a system bus 324. The system bus 324 can employ any suitable bus structures or architectures, including a memory bus with memory controller, a peripheral bus, and/or a local bus.

The mobile device 1 102 also includes one or more volatile and/or non-volatile storage medium(s) 312. The storage mediums 312 may be comprised of any single or suitable combination of various types of processor-readable storage media and may store instructions and data acted on by CPU 308. For example, a particular collection of software instructions comprising software 314 and/or firmware instructions comprising firmware are executed by CPU 308. The software or firmware instructions generally control many of the operations of the mobile device 1 102 and a subset of the software and/or firmware instructions may perform functions to operatively configure hardware and other software in the mobile device 1 102 to provide the initiation, control and maintenance of applicable computer network and telecommunication links from the mobile device 1 102 to another subscriber device such as mobile device 2 104 or landline telephone 110 via the network 116 as shown in FIG. 1 using the wireless receiver(s) and transmitter(s) 318, network interface(s) 320, and/or I/O ports 316.

By way of example, and not limitation, the storage medium(s) 312 may be processor-readable storage media which may comprise any combination of computer storage media including volatile and nonvolatile, removable and non-removable media implemented in any method or technology for storage of information such as computer readable instructions, data structures, program modules or other data. Combinations of any of the above should also be included within the scope of processor-readable storage media.

The storage medium(s) 312 may include system memory which includes computer storage media in the form of volatile and/or nonvolatile memory such as read-only memory (ROM) and random access memory (RAM). A basic input/output system (BIOS), containing the basic routines that help to transfer information between elements within mobile device 1 102, such as during start-up or power-on, is typically stored in ROM. RAM typically contains data and/or program modules that are immediately accessible to and/or presently being operated on by CPU 308. By way of example, and not limitation, FIG. 3 illustrates software modules 314 including an operating system, application programs and other program modules that implement the processes and methods described herein.

The mobile device 1 102 may also include other removable/non-removable, volatile/nonvolatile computer storage media drives. By way of example only, the storage medium(s) 312 may include a hard disk drive or solid state storage drive that reads from or writes to non-removable, nonvolatile media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in an operating environment of the mobile device 1 102 include, but are not limited to, flash memory cards, digital versatile disks, micro-discs, digital video tape, solid state RAM, solid state ROM, and the like. The storage medium(s) are typically connected to the system bus 324 through a non-removable memory interface. The storage medium(s) 312 discussed above and illustrated in FIG. 3, provide storage of computer readable instructions, data structures, program modules and other data for the mobile device 1 102. In FIG. 3, for example, a storage medium may store software 314 including an operating system, application programs, other program modules, and program data. The storage medium(s) 312 may implement a file system, a flat memory architecture, a database, or any other method or combination capable for storing such information.

A user may enter commands and information into the mobile device 1 102 through touch screen display 304 or the one or more other input device(s) 310 such as a keypad, keyboard, camera, motion sensor, position sensor, light sensor, biometric data sensor, accelerometer, or a pointing device, commonly referred to as a mouse, trackball or touch pad. Other input devices of the mobile device 1 102 may include a microphone, joystick, thumbstick, game pad, optical scanner, other sensors, or the like. These and other input devices are often connected to the CPU 308 through a user input interface that is coupled to the system bus 324, but may be connected by other interface and bus structures, such as a parallel port, serial port, wireless port, game port or a universal serial bus (USB). Generally, a unique software driver stored in software 314 configures each input mechanism to sense user input, and then the software driver provides data points that are acted on by CPU 308 under the direction of other software 314. The display is also connected to the system bus 324 via an interface, such as the graphics engine 306. In addition to the display 304, the mobile device 1 102 may also include other peripheral output devices such as speakers, a printer, a projector, an external monitor, etc., which may be connected through one or more analog or digital I/O ports 316, network interface(s) 320 or wireless receiver(s) and transmitter(s) 318.

The mobile device 1 102 may operate in a networked environment using connections to one or more remote computers or devices, such as a remote computer or device of the tracker 112, SPS 106, SPS 108, and/or BS 114 within or connected to the computer network 116 of FIG. 1 and described above. The remote computer within or connected to network 116 may be a personal computer, a server, a router, a network PC, a peer device or other common network node, and typically includes many or all of the elements described above relative to the computer system 200 of FIG. 2. Such connections to the network 116 may include connections over cellular, satellite, local area network (LAN) connections or wide area network (WAN) connections as described above, and/or other networks.

When used in a LAN or WAN networking environment, the mobile device 1 102 may be connected via the wireless receiver(s) and transmitter(s) 318 and network interface(s) 320, which may include, for example, cellular receiver(s) and transmitter(s), Wi-Fi receiver(s) and transmitter(s), and associated network interface(s). When used in a WAN networking environment, the mobile device 1 102 may include a modem or other means as part of the network interface(s) for establishing communications over the WAN, such as the Internet. The wireless receiver(s) and transmitter(s) 318 and the network interface(s) 320 may be communicatively connected to the system bus 324. In a networked environment, program modules depicted relative to the mobile device 1 102, or portions thereof, may be stored in a remote memory storage device of a remote system.

The mobile device 1 102 has a collection of I/O ports 316 and/or short range wireless receiver(s) and transmitter(s) 318 and network interface(s) 320 for passing data over short distances to and from the mobile device 1 102 or for coupling additional storage to the mobile device 1 102. For example, serial ports, USB ports, Wi-Fi ports, Bluetooth® ports, IEEE 1394 (i.e., FireWire), and the like can communicatively couple the mobile device 1 102 to other computing apparatuses. Compact Flash (CF) ports, Secure Digital (SD) ports, and the like can couple a memory device to the mobile device 1 102 for reading and writing by the CPU 308 or couple the mobile device 1 102 to other communications interfaces such as Wi-Fi or Bluetooth transmitters/receivers and/or network interfaces.

Mobile device 1 102 also has a power source 322 (e.g., a battery). The power source 322 may supply energy for all the components of the mobile device 1 102 that require power when a traditional, wired power source is unavailable or otherwise not connected. Other various suitable system architectures and designs of the mobile device 1 102 are contemplated and may be utilized which provide the same, similar or equivalent functionality as those described herein.

It should be understood that the various techniques described herein may be implemented in connection with hardware, software and/or firmware or, where appropriate, with a combination of such. Thus, the methods and apparatus of the disclosure, or certain aspects or portions thereof, may take the form of program code (i.e., instructions) embodied in tangible media, such as floppy diskettes, CD-ROMs, hard drives, flash drives, or any other machine-readable or processor-readable storage medium wherein, when the program code is loaded into and executed by a machine, such as a processor of a computer or mobile device, the machine becomes an apparatus for practicing various embodiments. In the case of program code execution on programmable computers or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system including the computer system 200 depicted in FIG. 2 and also in FIG. 3 of mobile device 1 102. However, the program(s) can be implemented in assembly or machine language, if desired. In any case, the language may be a compiled or interpreted language, and combined with hardware implementations.

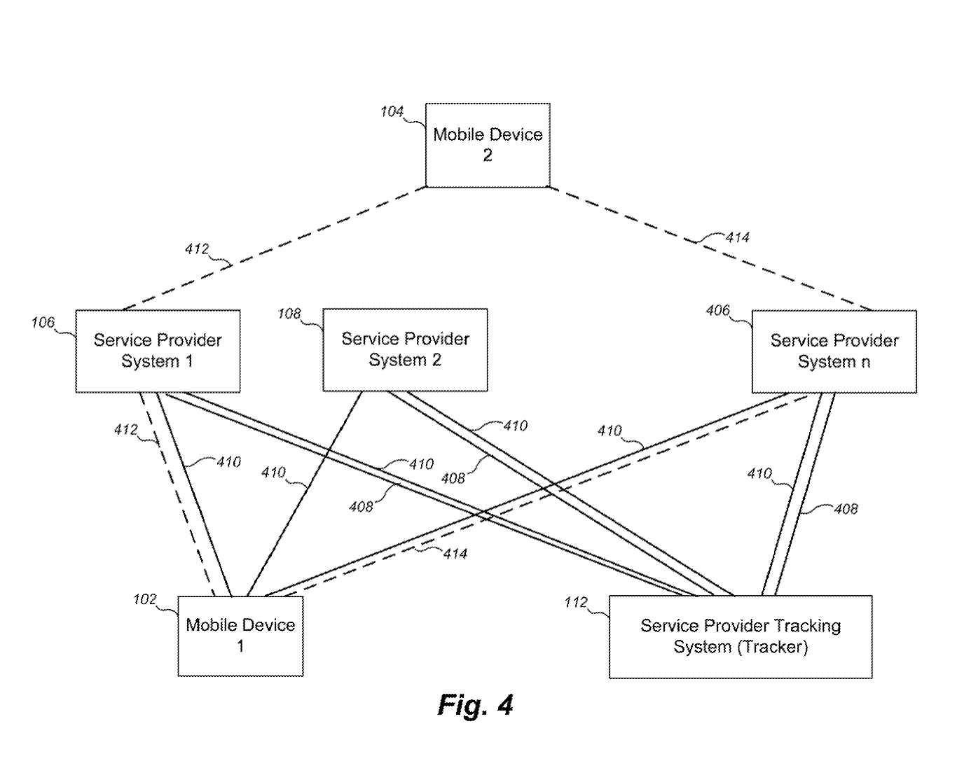

FIG. 4 is shows the architecture of a system 400 for dynamic selection of data and telecommunication service providers. Shown are various types of information that are communicated between the mobile device 1 102, mobile device 2 104, service provider system (SPS) 1 106, service provider system (SPS) 2 108, service provider system (SPS) n 406 and the service provider tracker system (tracker) 112, according to one illustrated embodiment. Additional mobile devices, service providers and a separate billing payment system such as that illustrated in FIG. 1 may also be present and included in the network environment, but are not illustrated.

In the example of FIG. 4, the service provider tracker 112 may continuously or periodically gather information regarding the cost of communication from all available service providers (e.g., SPS 1 106, SPS 2 108 and SPS n 406). For example, this information may be sent from SPS 1 106, SPS 2 108 and/or SPS n 406 to the tracker 112 in response to a request or query from the tracker 112 to SPS 1 106, SPS 2 108 and/or SPS n 406 (i.e., may be pulled from one or more service provider systems by the tracker 112). Additionally or alternatively, SPS 1 106, SPS 2 108 and/or SPS n 406 may periodically or continuously automatically send this information to the tracker 112 without receiving a query or request to do so from tracker 112 (i.e., may be pushed by one or more service provider systems to the tracker 112). This is represented in FIG. 4 by lines 408. For example, the information regarding cost of communication may include information regarding cellular service or data service usage rates according to usage time or amounts of data used, service fees, surcharges, taxes, roaming rates, or any other information regarding the cost of using the service provided by SPS 1 106, SPS 2 108 or SPS n 406. Other information may be gathered as described above regarding the signal strength, speed or bandwidth available from each available service provider. In some alternative embodiments, some or all the information described above (e.g., signal strength) may be pulled from the corresponding subscriber device by the tracker 112 or pushed by the corresponding subscriber device to the tracker 112.

As described above, there may be any number of available of service provider systems available in a given location and the disclosure is not limited to the number of example service provider systems shown in FIG. 4.

When mobile device 1 102 is initiating a communication with mobile device 2 104, mobile device 1 102 sends a request to the tracker 112 through any available service provider system for a preferred service provider system for a contemplated communication (e.g., for a cellular telephone call). The request to the tracker also may include a set of criteria for a selection of a desired/preferred provider. The preferred service provider system, may, for example, be a service provider system currently charging the least amount as compared to the other available service provider systems for using the service provider system to enable the communication from mobile device 1 102 to mobile device 2 104. Other considerations including the signal strength, quality of service, available bandwidth and speed from each available service provider system (SPS) may also be used in determining and selecting the preferred SPS. The routing of these requests is represented by lines 410. The tracker 112 then sends to the mobile device 1 102 an identifier (ID) of a selected preferred SPS, (e.g., an ID of SPS 1 106) to enable the mobile device 1 102 to establish a communication with the mobile device 2 104 through SPS 1 106.

The mobile device 1 102 may then establish a communication with the mobile device 2 104 through SPS 1 106. This communication is represented by dashed line 412. If during the communication between mobile device 1 102 and mobile device 2 104 the tracker 112 identifies a service provider system (e.g., service provider system n 406) offering service for less expense and/or having better communications services, the tracker 112 may send a request to the mobile device 1 102 to switch service provider system n 406. The routing of this request is represented by dashed lines 414.

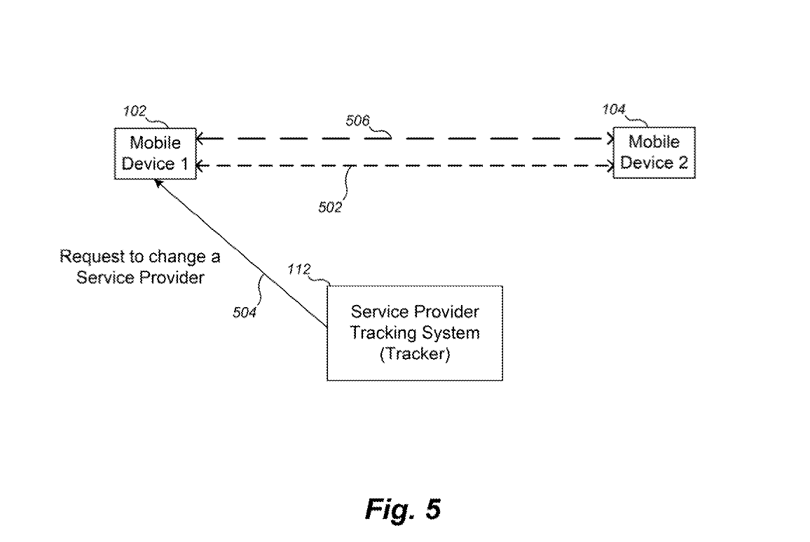

FIG. 5 illustrates switching from one service provider to another in the system 400 for dynamic selection of data and telecommunication service providers shown in FIG. 4, according to one illustrated embodiment. Shown in FIG. 5 are the mobile device 1 102 and mobile device 2 104 having a current communication session in progress on a first channel of communication 502. The communication session may be, for example, a voice or data communication session, such as a telephone call, video conference, sending and/or receiving streaming digital media, or a combination of both, etc. During the current communication session, tracker 112 may send a request 504 to mobile device 1 102 to change the service provider currently being used for the current communication session between mobile device 1 102 and mobile device 2 104. This may occur, for example, when the tracker 112 detects a preferable available service provider system based on cost, speed of service, quality of service or other considerations.

In response to the request 504, mobile device 1 102 may then establish a duplicate of the current communication session on second channel of communication 506 with mobile device 2 104 using the preferable available service provider system. Content of the current communication session 502 will be transmitted and received through the second channel while still conducting the current communication session 502 through the first channel. For example, this second channel may be initiated and operated using a different wireless transmitter and receiver of mobile device 1 102 and mobile device 2 104 than that used for the current channel of communication 502.

Mobile device 2 104 may then synchronize the two channels of communication 502 506 such that the same data being transmitted and received through the first channel of communication 502 and second channel of communication 506 is being transmitted and received at substantially the same time to make the dynamic switch to the preferable service provider less noticeable and more seamless. This synchronization may, for example, be made by adjusting a clock or timing signal on one or both of the mobile device 1 102 and the mobile device 2 104 used to process the signals carrying the information being transmitted and received. Once the synchronization is complete, the first channel of communication may be dropped or terminated by the mobile device 1 102 or the mobile device 2 104, thereby continuing the current communication session through the second channel of communication 506.

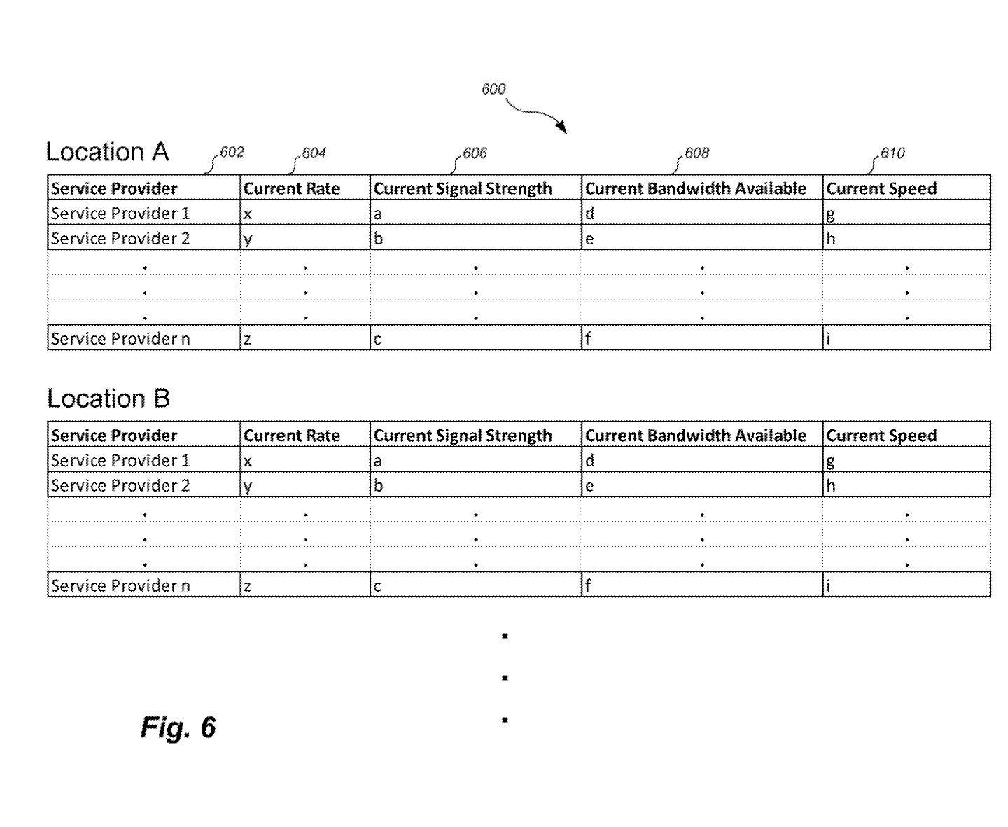

FIG. 6 is a diagram representing a database schema 600 for tracking rates and communication capabilities of n number of service providers for various locations used by the tracker 112. The tracker 112 may store or have access to stored information regarding rates and communication capabilities of service providers for various locations. For example, this information may be stored on the tracker computer system hard disk drive 200 such as that shown in FIG. 2, or on a remote storage device on a database hosted on another system connected to network 116 of FIG. 1. This information may include any information helpful in determining whether a particular service provider is preferable to use over another service provider based on service rates, other costs, quality of service, fidelity, speed, signal strength, bandwidth, service provider history, likelihood of having calls dropped, and other considerations. For example, shown in FIG. 6 is a table of information including example fields for storing such information in an organized manner within a database according to one example embodiment.

For example, shown are a service provider identification field 602, current rate field 604, current signal strength field 606, current bandwidth available field 608, and current speed field 610. The rate field may include information such as how much a particular service provider charges per minute or other amount of time or other unit of measurement for usage of the service. The rate field may also or instead include information or sub-fields storing information regarding how much the particular service provider charges per megabyte of data or other unit of data sent or received. Other information regarding rates may also be included such as the rates based on particular types of subscribers having particular types of end user equipment or subscriber devices, whether the particular user has an existing contract with the service provider, whether rollover minutes can be used from previous contracts or other pre-purchased minutes, and how the start and end of use is measured, e.g., from when the call is initiated or from when it is answered (i.e., charging from send-to-end), etc.

The current signal strength field 606 may store one or more indications of the strength of the cellular or other carrier signal provided by the particular service provider at or near a current location of a subscriber device. The current bandwidth available field 608 may store one or more indications of the current bandwidth available on a particular service provider's network and the current speed field 610 may store one or more indications regarding the speed at which data may be transmitted and/or received over a particular service provider's network and may be related to the current bandwidth available on the particular service provider's network. Also, the current rate field 604 may include one or more indications of different rates available for different desired speeds as indicated in the current speed field 610.

As shown, the schema 600 may be organized to store different data for particular service providers based on location as different service providers may be available in different locations and each service provider's rates, service quality, capabilities, and other features may vary across different locations (e.g., location A and B). The data stored in the database schema 600 may be continuously and dynamically updated by or on behalf of the tracker 112. This may be accomplished by the various service provider systems being continuously monitored and/or queried on demand as needed according to current usage and locations of individual subscriber devices.

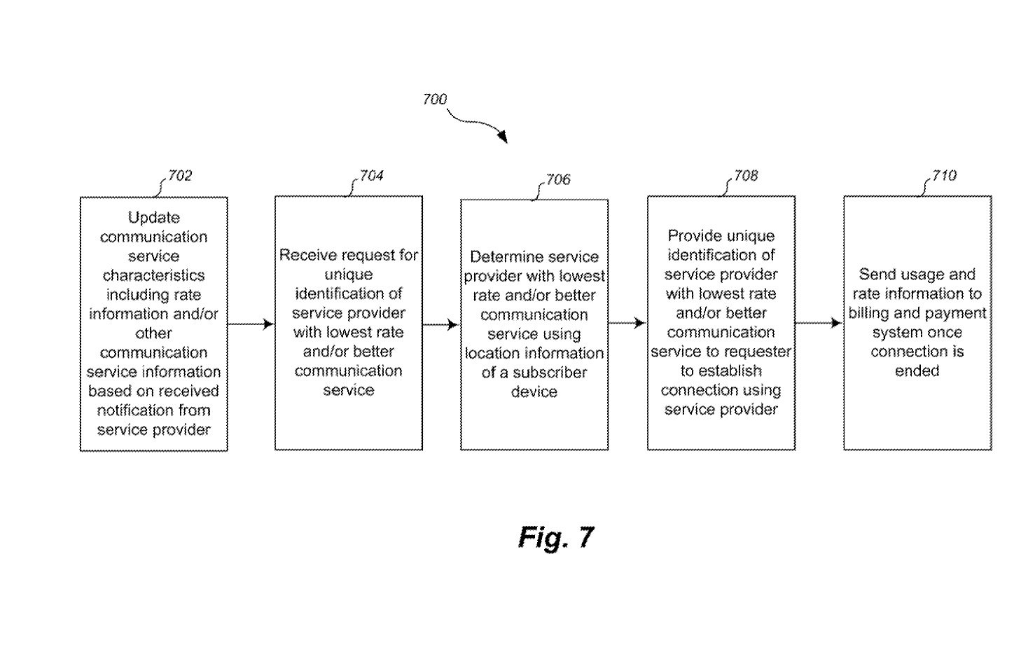

FIG. 7 is a flow diagram showing a method 700 of providing dynamic selection of data and telecommunication service providers, according to one illustrated embodiment. For example, in one embodiment, the tracker 112 of FIGS. 1 and 3 may perform or control performance of the method illustrated in FIG. 7.

At 702, communication service characteristics including rate information and/or other communication service information are updated based on a received notification from the service provider system. As described in more detail above, the communication service characteristics may include rate information and/or other communication service information including but not limited to communication service information including or related to the information stored in the database schema 600 shown in FIG. 6 and other information described above in connection with FIG. 6 regarding communication services of various service providers. For example, two or more service provider systems may automatically notify the tracker whenever there is any change in their rates for communication services or other communication service information or the tracker may continuously or periodically monitor or query various service provider systems to obtain the current rates or communications service information or statistics.

At 704, a request is received for a unique identification of a service provider system having the lowest rate and/or better communication service. In one embodiment, one or more subscriber devices (e.g., mobile device 1 102 and mobile device 2 104) subscribe to the tracker. When a subscriber device initiates a communication with another device, the initiating subscriber device automatically contacts the tracker and requests the unique identification of the network available at the location of the subscriber device with the lowest rate or better communication service. Alternatively, the tracker automatically determines that the subscriber device is attempting to initiate a communication by automatically and continuously or periodically monitoring the subscriber device.

At 706, the service provider with the lowest rate and/or better communication service is selected using location information of a subscriber device (e.g., by accessing the data stored in the database schema 600 shown in FIG. 6). The subscriber device may be a device of a subscriber to one or more of the service provider systems and/or of the tracker. Once the tracker is notified of or becomes aware that the subscriber device is attempting to initiate a communication, the tracker uses location data from the subscriber device and the tracker's own database to determine which SPS network at the location of the subscriber device has the lowest rate or better communication service.

At 708, a unique identification of the service provider with the lowest rate and/or better communication service is provided to the requester to establish a connection using the selected SPS and transmits the unique identification of that SPS to the subscriber device. The subscriber device may automatically use the unique identification data to automatically establish communication with another device using the SPS network. The subscriber device automatically notifies the tracker when the communication is established and when it is terminated. Alternatively, the tracker automatically confirms the initiation and termination of the communication by automatically and continuously monitoring the subscriber device.

At 710, usage and rate information is sent to a billing and payment system (e.g., BPS 114 of FIG. 1) once the connection is ended. For example, if the SPS rate is based on minutes of use, the tracker may calculate the duration of the communication from the information sent by the subscriber device and send the duration data together with the SPS rate to the BPS. If the SPS rate is based on units of data transmitted, the subscriber device reports the units of data transmitted to the tracker when notifying the tracker that the communication has been terminated and the tracker sends that data together with the SPS rate to the BPS. Alternatively, the tracker automatically determines the minutes of use or data units transmitted by automatically and continuously monitoring the subscriber device. Using the information sent by the tracker, the BPS automatically calculates the amount due from the owner of the subscriber device, the amount due to the SPS, the amount due to the tracker, if any, and the amount due to the BPS, if any. The BPS then automatically bills and collects the amount due from the owner of the subscriber device and, using that sum, automatically makes the payments due to the SPS, to the tracker and to itself.

In one embodiment, a payment procedure may be implemented based on an integrated model. For example, the tracker or entity that controls the tracker may purchase a particular amount of bandwidth from all or preferred service providers. The owners of the subscriber devices have an agreement with the tracker or entity that controls the tracker for communication services and the owners pay for selected communication services to the tracker. In this embodiment, the service providers charge the tracker or entity that controls the tracker for services rendered to the subscriber devices. Thus, the BPS then automatically bills and collects the amount due from the owner of the subscriber device and, using that sum, automatically makes the payments due the tracker. The BPS may be a part of the tracker or entity that controls the tracker, or a separate system remote from the tracker that provides the payment services to the tracker for a fee or percentage of the amounts due. Alternatively, any particular subscriber may pay directly to every service provider and the tracker for rendered services using the BPS.

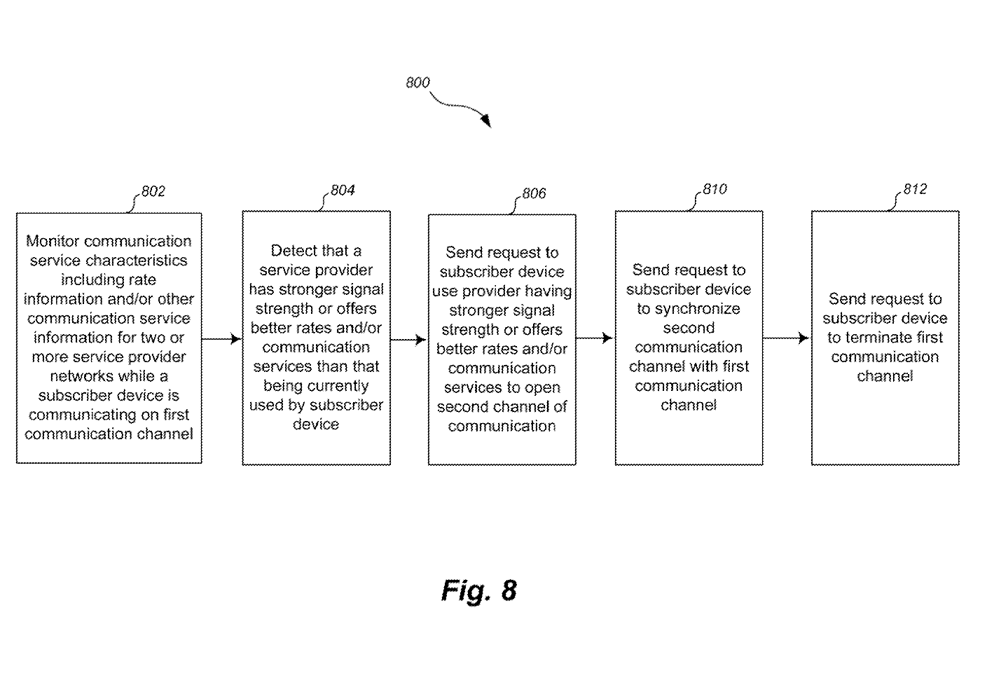

FIG. 8 shows a method 800 of providing dynamic selection of data and telecommunication service providers, according to one illustrated embodiment. For example, the tracker 112 of FIGS. 1 and 3 may perform or control performance of the method 800 illustrated in FIG. 8.

At 802, communication service characteristics including rate information and/or other communication service information are monitored for two or more service provider system networks while a subscriber device is communicating on a first communication channel using at least one of the two or more service provider system networks. In one example, the tracker automatically monitors the rates for two or more SPS networks, one of which is currently being used by the subscriber device, while the subscriber device is communicating on one channel with another device. Additionally or alternatively, the two or more service provider systems may automatically notify the tracker whenever there is any change in their rates or communication services.

At 804, the tracker detects that a service provider system has stronger signal strength or offers better rates and/or communication services than the service provider system currently being used by the subscriber device.

At 806, a request is sent to the subscriber device to use the provider having stronger signal strength or that offers better rates and/or communication services to open a second channel of communication. When the tracker learns that an SPS network at the location of the subscriber device has a lower rate or otherwise offers better communication service than the one currently being used by the subscriber device, the tracker may automatically send a request to the subscriber device to open a second channel of communication with the other device using the SPS network that has the lower rate or better communication service.

At 810, a request is sent to one or both of the subscriber devices to synchronize the second communication channel with the first communication channel (as explained in more detail with respect to FIG. 5). The subscriber device may automatically notify the tracker that the second channel of communication has been established and then the tracker automatically sends a request to the subscriber device to synchronize the second communication channel with the first communication channel. Alternatively, the tracker could automatically determine that the second channel of communication has been established by automatically and continuously or periodically monitoring the subscriber device.

At 812, a request is sent to one or both of the subscriber devices to terminate the first communication channel. For example, the subscriber device automatically notifies the tracker that the two channels of communication have been synchronized and then the tracker automatically sends a request for the subscriber device to terminate the first channel of communication. Alternatively, the tracker could automatically determine that the two communication channels have been synchronized by automatically and continuously monitoring one or both of the subscriber devices. Also, once the second communication channel is established, the subscriber device may alternatively automatically synchronize the two channels of communication and terminate the first channel of communication itself once the synchronization is complete without the requests being sent from the tracker to do so.

The tracker may automatically cause the subscriber device to switch SPS networks as many times as necessary during the communication to ensure that the subscriber device is using the SPS network available having the lowest cost and/or best communication service while the communication is in progress.

In addition, once the first channel of communication has been terminated, the amount due to the first terminated SPS network may automatically be calculated, billed, collected and distributed using the same or similar procedures described above in connection with FIG. 7. Once the second channel of communication has been terminated, the amount due to the second terminated SPS network can also be automatically be calculated, billed, collected and distributed using the same or similar procedures described above in connection with FIG. 7. These procedures may automatically be repeated for as many SPS networks as are used by the subscriber device during the communication.

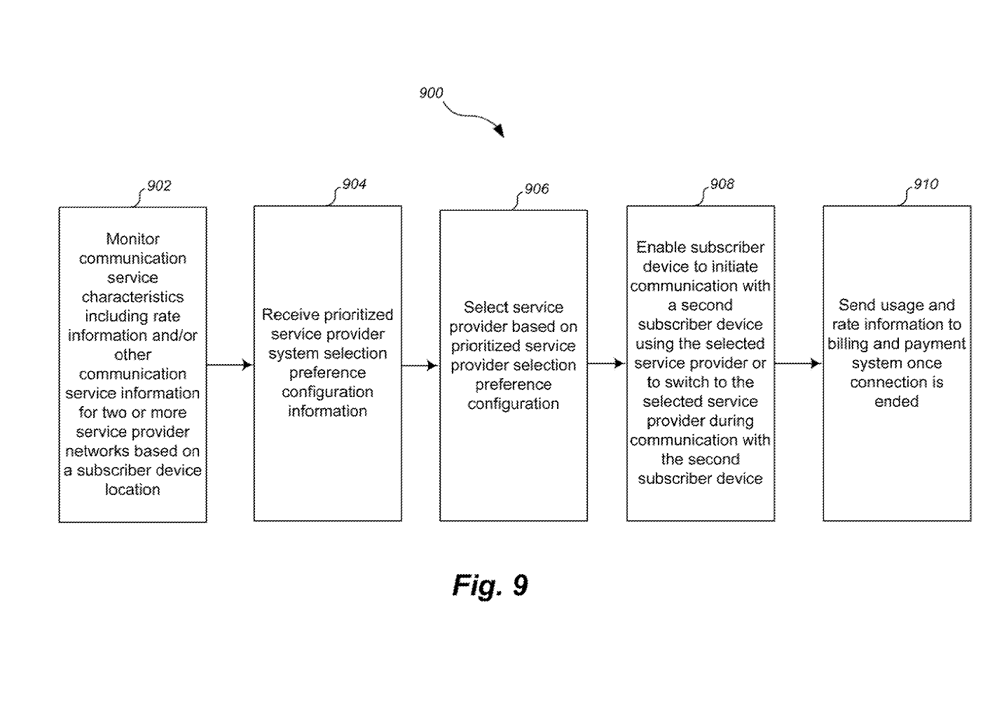

FIG. 9 shows a method 900 of providing dynamic selection of data and telecommunication service providers, according to one illustrated embodiment. For example, the tracker 112 of FIGS. 1 and 3 may perform or control performance of the method 800 illustrated in FIG. 8.

At 902, communication service characteristics including rate information and/or other communication service information are monitored for two or more service provider networks based on a subscriber device location.

At 904, prioritized service provider system selection preference configuration information is received (e.g., by tracker 112 of FIGS. 1 and 3). This selection preference configuration information may include information on which a selection of a service provider system is based. For example, the information may include instructions to select one communication service provider system over another based on whether one has better rates, signal, strength, speed, bandwidth, other communication service characteristics, or any combination of such characteristics. In some embodiments, certain communication service characteristics may be indicated in the configuration information as having a higher priority with respect to selection of a service provider system than other communication service characteristics. For example, the owner of the subscriber device could program the tracker to automatically select the initial or subsequent SPS network which first has the strongest signal, second, has the most available bandwidth and, third, has the lowest rate.

Accordingly, at 906, a service provider system is selected based on the prioritized service provider selection preference configuration information.

At 908, the subscriber device is enabled to initiate communication with a second subscriber device using the selected service provider or to switch to the selected service provider during communication with the second subscriber device. This may be accomplished in the same or similar manner as the processes described above in connection with FIGS. 5, 7 and 8 for initiating communication with a second subscriber device using the selected service provider or to switch to the selected service provider during communication with the second subscriber device.

At 910, usage and rate information is sent to a billing and payment system (e.g., BPS 114 of FIG. 1) once each connection is ended with various selected service provider systems as described above with respect to FIGS. 7 and 8.

The above description of illustrated embodiments, including what is described in the Abstract, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary communication service provider systems generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of non-transitory signal bearing media include, but are not limited to, the following: recordable type media such as floppy disks, hard disk drives, CD ROMs, digital tape, and computer memory; and other non-transitory computer-readable storage media.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method of selecting communication service providers, the method comprising:
automatically acquiring communication service characteristics of available communication service providers;
automatically selecting a first communication service provider system based on the first communication service provider system having preferable communication service characteristics as compared to communication service characteristics of a second communication service provider system; and
automatically communicating identification information regarding the first communication service provider system to a first subscriber device to enable the first subscriber device to conduct a communication session with a second subscriber device using the identification information regarding the first communication service provider system.

2. The method of claim 1 wherein the communication service characteristics include at least one of: a rate for use of communication services based on an amount of time, a rate for use of communication services based on an amount of data, wireless carrier signal strength, available network bandwidth, characteristics regarding network speed, or quality of communication services characteristic.

3. The method of claim 1 wherein the preferable communication service characteristics are those characteristics that have at least one of: a lower rate for usage of communication services, a stronger signal strength, a higher bandwidth, a higher network speed, or a higher quality of service characteristics as compared to other communication service providers.

4. The method of claim 1 wherein the automatically selecting the first communication service provider system comprises:
receiving information regarding a location of the first subscriber device;
storing the communication service characteristics of the first communication service provider system and the communication service characteristics of the second communication service provider system, wherein the communication service characteristics of the first communication service provider system and second communication service provider system are applicable to the location of the first subscriber device; and
comparing the stored communication service characteristics of the first communication service provider system and the stored communication service characteristics of the second communication service provider system to determine which communication service provider system has preferable communication service characteristics based on the location of the first subscriber device.

5. The method of claim 1 wherein the automatically communicating identification information regarding the first communication service provider system occurs while the first subscriber device is conducting a current communication session on a first channel of communication with the second subscriber device via the second communication service provider system, and further comprising sending information to the first subscriber device to enable the first subscriber device to switch to using the first communication service provider system for conducting the current communication session.

6. The method of claim 5 wherein the sending information to the first subscriber device to enable the first subscriber device to switch to using the first communication service provider system for conducting the current communication session comprises:
sending a request to the first subscriber device to use the first communication service provider system to open a second channel of communication with the second subscriber device;
sending a request to the first subscriber device or the second subscriber device to synchronize the second channel of communication with the first channel of communication; and
sending a request to the first subscriber device or the second subscriber device to terminate the first communication channel.

7. The method of claim 1 wherein at least one of the first subscriber device or the second subscriber device is a wireless mobile device or a telephone.

8. The method of claim 1 wherein the communication session includes at least one of: a telephone call, a video conference call, a sending of or a receiving of an electronic message, or a session in which content of the session is streaming audio or video data.

9. The method of claim 1, further comprising sending usage and rate information associated with the first subscriber device using the first communication service provider system to conduct the communication session.

10. The method of claim 1 wherein the automatically selecting the first communication service provider system based on the first communication service provider system having preferable communication service characteristics is based at least in part on received prioritized communication service provider system selection preference information including instructions to select one communication service provider system over another based on particular individual communication service characteristics having a higher priority than other particular individual communication service characteristics.

11. A computer-implemented method of selecting communication service provider systems, the method comprising:
receiving identification information at a first subscriber device regarding an available first communication service provider system having preferable communication service characteristics as compared to communication service characteristics of an available second communication service provider system; and
conducting a communication session with a second subscriber device using the identification information regarding the first communication service provider system.

12. The method of claim 11, further comprising sending information regarding a location of the first subscriber device to enable the received identification information regarding an available first communication service provider system to be based on the location of the first subscriber device.

13. The method of claim 11 wherein the receiving identification information regarding the first communication service provider system occurs while the first subscriber device is conducting a current communication session on a first channel of communication with the second subscriber device using the second communication service provider system, and wherein the conducting a communication session with the second subscriber device using the identification information regarding the first communication service provider system comprises:
opening a second channel of communication with the second subscriber device using the first communication service provider system;
synchronizing the second channel of communication with the first channel of communication; and
terminating the first communication channel and continuing the current communication session using the first communication service provider system instead of the second communication service provider system.

14. A system comprising:
a computer processor;
a network interface for receiving information regarding communication service providers;
a non-transitory memory communicatively coupled to the computer processor having computer-executable instructions stored thereon that when executed by the computer processor cause the computer processor to perform:
automatically selecting a first communication service provider system based on the first communication service provider system having preferable communication service characteristics as compared to communication service characteristics of a second communication service provider system; and
automatically communicating identification information regarding the first communication service provider system to a first subscriber device to enable the first subscriber device to conduct a communication session with a second subscriber device using the identification information regarding the first communication service provider system.

15. The system of claim 14 wherein the communication service characteristics include at least one of: a rate for use of communication services based on an amount of time, a rate for use of communication services based on an amount of data, wireless carrier signal strength, an available network bandwidth, characteristics regarding network speed, or a quality of communication services characteristic.

16. The system of claim 14 wherein the preferable communication service characteristics include at least one of: a lower rate for usage of communication services, a stronger signal strength, a higher bandwidth, a higher network speed, or a higher quality of service characteristic as compared to other communication service.

17. The system of claim 14 wherein the selecting the first communication service provider system comprises:
receiving information regarding a location of the first subscriber device;
storing the communication service characteristics of the first communication service provider system and the communication service characteristics of the second communication service provider system, wherein the communication service characteristics of the first communication service provider system and the second communication service provider system are applicable to the location of the first subscriber device; and
comparing the stored communication service characteristics of the first communication service provider system and the stored communication service characteristics of the second communication service provider system to determine which communication service provider system has preferable communication service characteristics based on the location of the first subscriber device.

18. The system of claim 14 wherein the computer-executable instructions, when executed by the computer processor, configure the computer processor to enable the automatically communicating identification information regarding the first communication service provider to occur while the first subscriber device is conducts a current communication session on a first channel of communication with the second subscriber device via the second communication service provider system, and wherein the computer-executable instructions, when executed by the computer processor, further cause the computer processor to perform sending information to the first subscriber device to enable the first subscriber device to switch to using the first communication service provider system to conduct the current communication session.

19. The system of claim 18 wherein the sending information to the first subscriber device to enable the first subscriber device to switch to using the first communication service provider system to conduct the current communication session comprises:
sending a request to the first subscriber device to use the first communication service provider system to open a second channel of communication with the second subscriber device;
sending a request to the first subscriber device or the second subscriber device to synchronize the second channel of communication with the first channel of communication; and
sending a request to the first subscriber device or the second subscriber device to terminate the first communication channel.

20. The system of claim 14 wherein at least one of the first subscriber device or second subscriber device is a wireless mobile device or a telephone.

21. The system of claim 14 wherein the communication session includes at least one of: a telephone call, a video conference call, a sending of or a receiving of an electronic message, or a session in which content of the session is streaming audio or video data.

22. The system of claim 14 wherein the computer-executable instructions, when executed by the computer processor, further cause the computer processor to perform sending usage and rate information associated with the first subscriber device using the first communication service provider system to conduct the communication session.

23. The system of claim 14 wherein the automatically selecting the first communication service provider system based on the first communication service provider system having preferable communication service characteristics is based at least in part on received prioritized communication service provider system selection preference information including instructions to select one communication service provider system over another based on particular individual communication service characteristics having a higher priority than other particular individual communication service characteristics.

24. A mobile communications device comprising:
a processor;
a wireless transmitter coupled to the processor;
a wireless receiver coupled to the processor;
an input device coupled to the processor;
an audio or video output device coupled to the processor; and
a memory coupled to the processor having computer-executable instructions thereon that when executed by the processor cause the processor to operate with the transmitter and the receiver to:
receive identification information at the mobile device regarding an available first communication service provider system having preferable communication service characteristics as compared to communication service characteristics of an available second communication service provider system; and
conduct a communication session with a subscriber device using the identification information regarding the first communication service provider system.

25. The device of claim 24 wherein the computer-executable instructions, when executed by the processor, further cause the processor to send information regarding a location of the mobile device to enable the received identification information regarding an available first communication service provider system to be based on the location of the mobile device.

26. The device of claim 24 wherein the computer-executable instructions, when executed by the processor, configure the processor to receive identification information regarding the first communication service provider while the mobile device conducts a current communication session on a first channel of communication with the subscriber device using the second communication service provider system, and wherein the subscriber device conducts the communication session using the identification information regarding the first communication service provider system by:
opening a second channel of communication with the subscriber device using the first communication service provider system;
synchronizing the second channel of communication with the first channel of communication; and
terminating the first communication channel and continuing the current communication session using the first communication service provider system instead of the second communication service provider system.

27. At least one non-transitory computer-readable medium that stores instructions that when executed by at least one computer system cause the at least one computer system to perform:
automatically selecting a first communication service provider system based on the first communication service provider system having preferable communication service characteristics as compared to communication service characteristics of a second communication service provider system; and
automatically communicating identification information regarding the first communication service provider system to a first subscriber device to enable the first subscriber device to conduct a communication session with a second subscriber device using the identification information regarding the first communication service provider system.

28. The at least one non-transitory computer-readable medium of claim 27 wherein the communication service characteristics include at least one of: a rate for use of communication services based on an amount of time, a rate for use of communication services based on an amount of data, a wireless carrier signal strength, an available network bandwidth, a characteristic regarding network speed, or a quality of communication services characteristic.

29. The at least one non-transitory computer-readable medium of claim 27 wherein the preferable communication service characteristics include at least one of: a lower rate for usage of communication services, a stronger signal strength, a higher bandwidth, a higher network speed, or a higher quality of service as compared with another communications service provider.

30. The at least one non-transitory computer-readable medium of claim 27 wherein the automatically selecting the first communication service provider system comprises:
receiving information regarding a location of the first subscriber device;
storing the communication service characteristics of the first communication service provider system and the communication service characteristics of the second communication service provider system, wherein the communication service characteristics of the first communication service provider system and the second communication service provider system are applicable to the location of the first subscriber device; and
comparing the stored communication service characteristics of the first communication service provider system and the stored communication service characteristics of the second communication service provider system to determine which communication service provider system has preferable communication service characteristics based on the location of the first subscriber device.

31. The at least one non-transitory computer-readable medium of claim 27 wherein the instructions, when executed by the at least one computer system configure the at least one computer system to enable the automatically communicating identification information regarding the first communication service provider to occur while the first subscriber device is conducting a current communication session on a first channel of communication with the second subscriber device using the second communication service provider system, and wherein the instructions, when executed by the at least one computer system, further cause the at least one computer system to perform sending information to the first subscriber device to enable the first subscriber device to switch to using the first communication service provider system for conducting the current communication session.

32. The at least one non-transitory computer-readable medium of claim 31 wherein the sending information to the first subscriber device to enable the first subscriber device to switch to using the first communication service provider system for conducting the current communication session comprises:
sending a request to the first subscriber device to use the first communication service provider system to open second channel of communication with the second subscriber device;
sending a request to the first subscriber device or the second subscriber device to synchronize the second channel of communication with the first channel of communication; and
sending a request to the first subscriber device or the second subscriber device to terminate the first communication channel.

33. The at least one non-transitory computer-readable medium of claim 27 wherein at least one of the first subscriber device or second subscriber device is a wireless mobile device or a telephone.

34. The at least one non-transitory computer-readable medium of claim 27 wherein the communication session includes at least one of: a telephone call, a video conference call, a sending of or a receiving of an electronic message, or a session in which content of the session is streaming audio or video data.

35. The at least one non-transitory computer-readable medium of claim 27 wherein the instructions, when executed by the at least one computer system, further cause the at least one computer system to perform sending usage and rate information associated with the first subscriber device using the first communication service provider system to conduct the communication session.

36. The at least one non-transitory computer-readable medium of claim 27 wherein the automatically selecting the first communication service provider system based on the first communication service provider system having preferable communication service characteristics is based at least in part on received prioritized communication service provider system selection preference information including instructions to select one communication service provider system over another based on particular individual communication service characteristics having a higher priority than other particular individual communication service characteristics.
